(19) United States
(12) Patent Application Publication
(10) Pub. No.: US 2008/0285951 A1
(43) Pub. Date: Nov. 20, 2008

(54) VIDEO/AUDIO REPRODUCING APPARATUS AND METHOD FOR OUTPUTTING SIGNAL IN VIDEO/AUDIO REPRODUCING APPARATUS

(75) Inventors: Hideaki Takahashi, Fussa-shi (JP); Koji Maruyama, Akishima-shi (JP); Takanobu Mukaide, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/119,889

(22) Filed: May 13, 2008

(30) Foreign Application Priority Data
May 16, 2007 (JP) 2007-130974

(51) Int. Cl. H04N 5/91

(52) U.S. Cl. 386/96

(57) ABSTRACT

According to one embodiment, a video/audio reproducing apparatus includes a detection/determination part, a setting processing part, and an output signal processing part. The detection/determination part obtains a format of reproducible audio data and video data. The setting processing part receives bit stream data in a reproducing apparatus from among the format of the audio data and the video data, which has been obtained by the detection/determination part and can be reproduced by the reproducing apparatus, and detects that the reproducing apparatus capable of reproducing the bit stream data is connected. The output signal processing part directly receives the bit stream data to output the bit stream data to the reproducing apparatus capable of reproducing the bit stream data when the setting processing part receives the bit stream data and detects that the reproducing apparatus capable of reproducing the bit stream data is connected.

### CROSS-REFERENCE TO RELATED APPLICATIONS

This application is based upon and claims the benefit of priority from Japanese Patent Application No. 2007-130974, filed May 16, 2007, the entire contents of which are incorporated herein by reference.

### BACKGROUND

1. Field

One embodiment of the invention relates to a video/audio reproducing apparatus which can set audio specification (audio format) independently of video specification to be output, in accordance with an audio reproduction ability of a device connected to the video/audio reproducing apparatus, and a method for outputting a signal in the video/audio reproducing apparatus.

2. Description of the Related Art

As an apparatus which can reproduce video and audio information recorded in an optical disc as a recording medium, a player apparatus for reproducing video from an optical disc of a DVD standard and a recorder apparatus capable of recording video information in the optical disc of the same format have been practically used for a long time.

Nowadays, an optical disc of a format where the DVD standard is developed has already been put in practical use, and the player apparatus and the recorder apparatus are available.

In the player apparatus capable of reproducing video and audio from content stored in the optical disc, in many cases, bidirectional communication interface typified by an HDMI (High-Definition Multimedia Interface), for example, is mounted.

Therefore, a sound specification (sound format), which can be reproduced by an audio equipment, a video/audio reproducing apparatus, that is, an AV controller (and a speaker), and a TV receiver which are respectively connected to the player apparatus, can be detected on the player apparatus side through the HDMI.

Meanwhile, in certain optical discs, in addition to a standard content format, an advanced content format, which is provided independently of the standard content format, is provided. Although a video software, which stores advanced content conforming to the advanced content format, is already available, there are some software (contents) having a different format of main audio, sub-audio, and effect audio in a part of the audio data.

For example, Japanese Patent Application Publication (KOKAI) No. 2006-294120 discloses that, when a reproducing apparatus reproduces content having a plurality of encoded audio data, even if a user is not conscious of an encoding method to be applied, the reproducing apparatus obtains information, which shows an audio reproduction condition from an apparatus inherent information part of an output apparatus side, through a digital interface, whereby the encoding method of the audio data, which is reproduced in the reproducing apparatus, is selected, and at the same time, the reproducing apparatus converts the audio data into an output data format style, which can be received and reproduced on the output apparatus side, to output the converted audio data.

However, the Publication 2006-294120, although the audio reproduction condition (from EDID (Extended Display Identification Dada)) is obtained from a receiving side, this document does not disclose a method for changing an output method of main, sub, and effect audio and main and sub video data in accordance with a user setting and the kind of audio stream.

Therefore, for example when content having both the sub audio and the effect audio is reproduced, a user is required to understand the reproduction ability of a reproducing apparatus (receiving side), and to perform special operations such as preventing a specified audio from being output.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing an example of a video/audio reproducing apparatus (player apparatus) according to an embodiment of the invention;

FIG. 2 is an exemplary diagram showing an example of content, which is stored in an optical disc and can be reproduced in the player apparatus shown in FIG. 1, according to an embodiment of the invention;

FIG. 3 is an exemplary diagram showing an example of a constitution of a file system of the optical disc shown in FIG. 2, according to an embodiment of the invention;

FIGS. 4A to 4H are exemplary diagrams each showing an example of a constitution of a file system of the optical disc shown in FIGS. 2 and 3, according to an embodiment of the invention;

FIG. 5 is an exemplary diagram showing an example of a constitution of an output signal processing part of the player apparatus shown in FIG. 1, according to an embodiment of the invention;

FIG. 6 is a flowchart showing an example of a method for detecting a receiver, which can reproduce HBR audio and a control of output of the HBR audio, according to an embodiment of the invention;

FIG. 7 is an exemplary diagram showing an example of an output of the HBR audio and the corresponding format in the receiver (receiving device) shown in FIG. 6, according to an embodiment of the invention;

FIG. 8 is an exemplary diagram showing an example of display indicating that the HBR audio, having been discriminated in the flowchart shown in FIG. 6, is being reproduced, according to an embodiment of the invention; and

FIG. 9 is an exemplary diagram showing an example of display indicating that the HBR audio, having been discriminated in the flowchart shown in FIG. 6, cannot be reproduced, according to another embodiment of the invention.

### DETAILED DESCRIPTION

Various embodiments according to the invention will be described hereinafter with reference to the accompanying drawings. In general, according to one embodiment of the invention, an optical disc device comprising: moving an actuator holding a lens which converges light from a light source on a recording layer of a recording medium to a predetermined position distant from the recording layer of the recording medium, and then locating the actuator in a direction to gradually approach the recording layer of the recording medium; finding, from a movement amount which inverts the polarity of an output of a photodetector, a first output obtained a predetermined amount before the movement amount which inverts the polarity of the output of the photodetector output by the movement of the lens, and a second output obtained a predetermined amount after the movement amount which inverts the polarity of the output of the photodetector, with regard to each of the surface of a transparent substrate of the recording medium and the recording layer thereof; finding the thickness of the transparent substrate at a plurality of radial positions in a recording surface of the recording medium and at a plurality of positions on the same radius, from the surface of the transparent substrate and the recording layer which have been found; and correcting a focal distance inherent in the lens by use of the thickness of the transparent substrate found at the plurality of radial positions in the recording surface of the recording medium and at the plurality of positions on the same radius.

Embodiments of this invention will be described in detail with reference to the drawings.

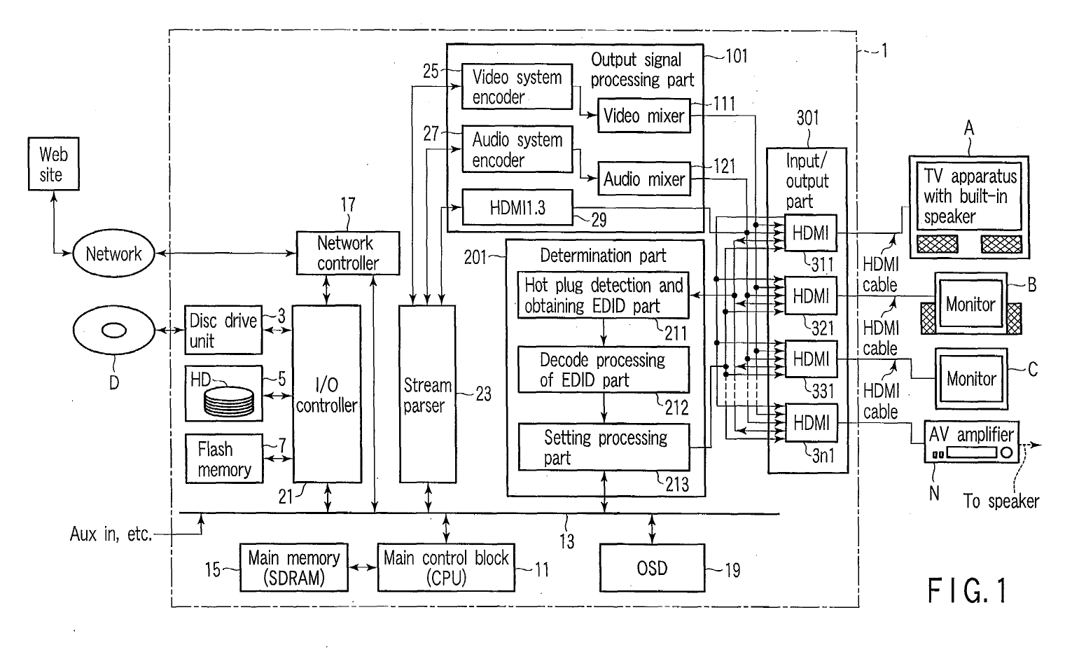

FIG. 1 is a schematic block diagram of a video/audio reproducing apparatus (player apparatus) to which an example of an embodiment of the invention can be applied. The video/audio reproducing apparatus according to the invention is not limited to the player apparatus, and includes a recorder apparatus, a video camera, and the like, in which video and audio can be recorded. Needless to say, a personal computer (PC), a disc drive apparatus connectable to the PC, or a navigation apparatus mounted in a car or the like may be applied to the video/audio reproducing apparatus of the invention. The video/audio reproducing apparatus may be referred to as a transmitting apparatus (or transmitting/receiving apparatus) because it provides a function as a signal transmission apparatus (transmitting apparatus) for an apparatus to which the video/audio reproducing apparatus is connected, such as a TV (television) receiving apparatus, a monitor apparatus capable of displaying television programs and so on, and an AV (Audio-Video) amplifier (controller).

A video/audio reproducing apparatus 1 shown in FIG. 1 includes a disc drive unit 3, a hard disc drive (HDD) unit 5, a flash memory 7 which is a nonvolatile semiconductor memory, and the like. When a recording medium such as a DVD disc or an optical disc M is set in the disc drive unit 3, the disc drive unit 3 can reproduce information contained in the optical disc M. The optical disc M has an HD DVD format where a DVD format is extended, and information can be recorded and reproduced therein/therefrom by using laser light having a wavelength of 405 nm. The HDD unit 5 includes a hard disc HD used as a persistent storage (hereinafter referred to as P-storage).

The disc drive unit 3, the HDD unit 5, and the flash memory 7 are connected to a main control block 11 including a CPU through a data bus 13 and an I/O controller 21. A main memory (SDRAM) 15, a network controller 17, an OSD 19, and the like are connected to the data bus 13.

The data held in a DVD disc M, the HDD unit 5, and the flash memory 7 has a data format referred to as well-known packetized stream (hereinafter referred to as “PS”). Although not described herein, a recorder apparatus, in which the capacity of the HDD unit 5 has been increased, can record a digital broadcasting wave from the ground or satellite, which has been received by a television tuner part (not shown) (or input through an aux in). Note that the digital broadcasting has a transport stream (hereinafter referred to as “TS”) format.

The video and audio, and other control data are time-division multiplexed in the PS. The video and audio are sent in a compressed form in order to reduce each data amount to be sent. The data is video data in many cases, and compressed in accordance with a format such as H.264, VC1, MPEG2, and MPEG4 AVC (often simply referred to as AVC).

The data taken through the I/O controller 21, for example content in an HD DVD disc is stored in the SDRAM (main memory) 15 through the data bus 13. When being reproduced, the content is input in a stream parser 23.

In an output signal processing part 101, the data input in the stream parser 23 is separated into video, that is, a video signal, audio (including music), that is, an audio signal, and high-bits rate audio (hereinafter referred to as HBR audio), which is supplied to a receiving apparatus (for example, a TV receiving apparatus and an AV amplifier) as it is (without being decoded). The data except the HBR audio is decoded by each corresponding video system decoder 25 and audio system decoder 27 to be supplied to the post-stage video mixer 111 and audio mixer 121. Meanwhile, the HBR audio signal is output to an HDMI input/output part 301 as it is through an HDMI (High-Definition Multimedia Interface) 1.3 unit 29.

The decoded video signal, that is, the video, is output through the HDMI input/output part 301 such that the video can be displayed on, for example, a general television (TV) apparatus A, a monitor apparatus B or C typified by for example a liquid crystal display and a CRT.

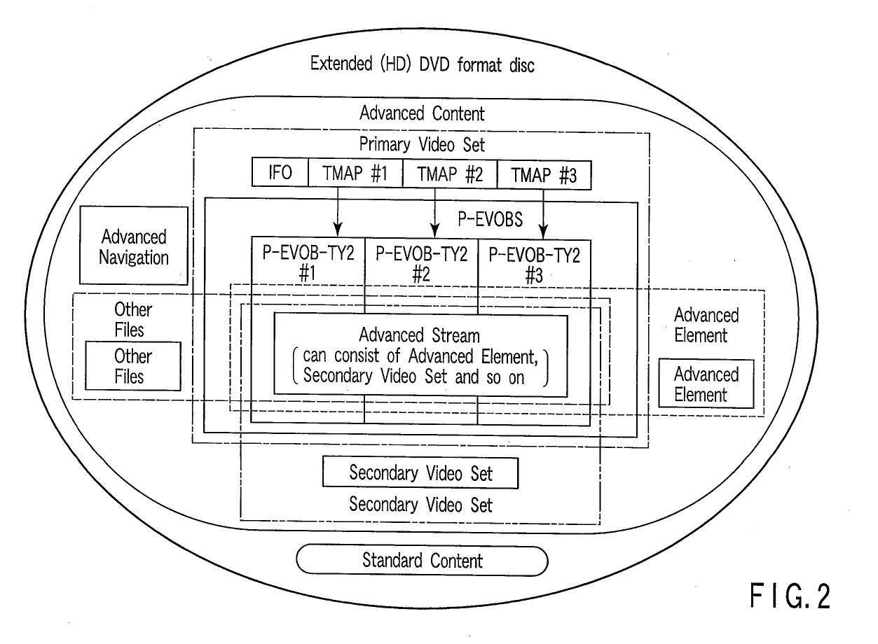

Meanwhile, the HBR audio signal (not decoded) or the audio signal decoded by the audio system decoder 27, that is, music or audio, is output from the HDMI input/output part 301 to the TV apparatus A with a built-in speaker, the AV amplifier N connected with a speaker or the like (not shown), or a speaker (not shown) connected to the monitor apparatus B or C (or the speaker may be integrally built in the monitor). In FIG. 1, the monitor apparatus B has an integrally provided external speaker, while the monitor apparatus C does not have an external speaker, whereby the audio (music) output from the HDMI input/output part 301 is output from a speaker (not shown) connected to the AV amplifier N. Meanwhile, whether the content recorded in the optical disc M contains the HBR audio signal (not decoded) or not can be easily discriminated by referring to “sub_stream_id” specified in an A_pack in an AVOBU (advanced video object unit) in an advanced object group recording region in a data structure of the optical disc M to be described hereinafter using FIGS. 2 to 4.

The network controller 17 can receive and transfer data between an arbitrary number of disc reproducing apparatuses on an external server (web site) or a local area network (LAN), through a public communication network or the LAN.

The external server includes a web site developed by the source of the DVD disc M and a specified destination, which is designated by or tied up with the disc supply source, and contains a distribution site (content provider) providing content for free or charge. As a disc reproducing apparatus capable of being connected onto the network, there are a portable type disc reproducing apparatus containing substantially the same function as the disc reproducing apparatus 1 and a disc reproducing apparatus, which is provided in other place at home for example and has the same format as the disc reproducing apparatus 1 or has other format capable of reproducing the DVD disc M.

In the disc reproducing apparatus 1 shown in FIG. 1, when a commercially available DVD disc or a disc corresponding to the format where the DVD format is extended, that is, a video software, is set and reproduced in the disc drive unit 3, it is possible to access a web site of the source of the disc, which is provided as an address or link destination information for recommending access to the source of the content accommodated in the optical disc, and a specified destination tied up with the disc supply source, through the network controller 17.

The user accesses the web site of the disc supply source, which is provided in the DVD disc or the disc corresponding to the format where the DVD format is extended, whereby the user can arbitrarily download a video added after the manufacture of the video software, such as an original program provided as benefit for the subscriber of the video software, and additional content, such as the audio of other language not stored in the video software. As the additional content, there is content referred to as “What's new” which is the guide of other video software supplied by the same source.

The additional content obtained by the download is stored in, for example, the hard disc HD of the HDD unit 5 or the flash memory 7.

Therefore, when the optical disc is reproduced in the disc reproducing apparatus, the additional content provided by the content supply source is downloaded from the network, whereby the additional content and the content stored in the DVD disc can be reproduced simultaneously, or in parallel.

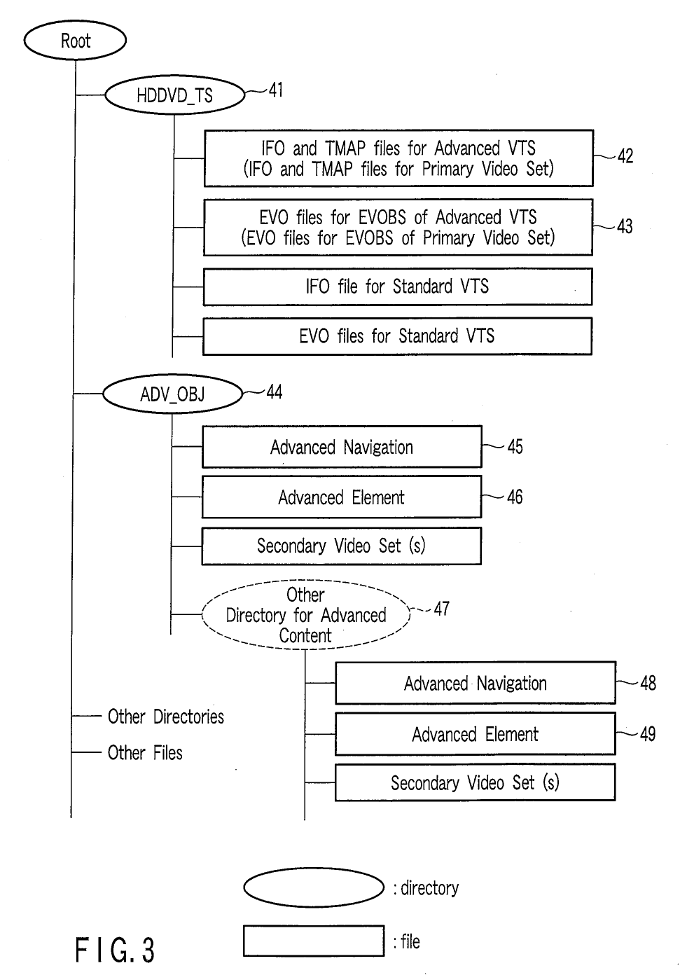

Meanwhile, when the recording medium mounted in the disc drive unit 3 of the disc reproducing apparatus (player apparatus) 1 is the DVD disc or the disc having the format where the DVD format is extended, the content stored in the disc contains content referred to as advanced content to be described hereinafter using FIG. 2 and content referred to as advanced directory to be described hereinafter using FIG. 3.

As shown in FIG. 2, the optical disc having the format where the DVD format is extended can store the advanced content and standard content. As a data type of the advanced content, there are an advanced navigation, an advanced element, a primary video set, a secondary video set, and the like.

An advanced stream is a data format for archiving any type of advanced content file except the primary video set. The advanced stream is multiplexed to a primary enhanced video object type 2 (P-EVOBS-TY2), and then drawn together with P-EVOBS-TY 2 data supplied to the primary video player.

The same file that is archived in the advanced stream and is necessary for reproducing the advanced content is required to be stored as a file. These copies guarantee the advanced content reproduction. This is because advanced stream supply may not be completed when reproduction of the primary video set is jumped. In this case, necessary files are directly read from a disc to Data Cache before restarting reproduction from a designated jump position.

[Advanced Navigation]

An advanced navigation file is ranked as a file. The advanced navigation file is read during a startup sequence, and is interpreted for the reproduction of the advanced content.

[Advanced Element]

The advanced element can be ranked as a file and further can be archived in the advanced stream multiplexed to P-EVOB-TY 2 data.

[Primary Video Set(s)]

Only one primary video set exists on a disc.

[Secondary Video Set]

The secondary video set can be ranked as a file and further can be archived in the advanced stream multiplexed to the P-EVOB-TY 2 data.

Other Files:

Other files may be provided (exist), depending on the advanced content.

FIG. 3 is a schematic view for explaining a file system, which is stored in a disc having the format where the DVD format is extended in FIG. 2, that is, for explaining structures of directories and files. As shown in FIG. 3, files for advanced content are preferably positioned in directories.

[Expansion DVD_TS Directory]

Expansion DVD_TS Directory 41 is immediately under the root directory. One advanced VTS 42 and 43 for the primary video set and one or a plurality of standard video sets are defined under this directory.

[ADV_OBJ (Advanced Video_Object) Directory]

ADV_OBJ Directory 44 is just under the root directory. All startup files belonging to an advanced navigation 45 are in this directory. All files of the advanced navigation 45, advanced element 46, and secondary video set are in this directory.

[Other Directories for Advanced Content]

Other directories for advanced content can exist only under the ADV_OBJ directory. The files of an advanced navigation 48, advanced element 49, and the secondary video set can be placed in this directory. The directory name is configured by d-characters and d1-characters. The total number of ADV_OBJ sub-directories (excluding ADV_OBJ directory) is less than 512. The depth of the directory hierarchy is 8 or less.

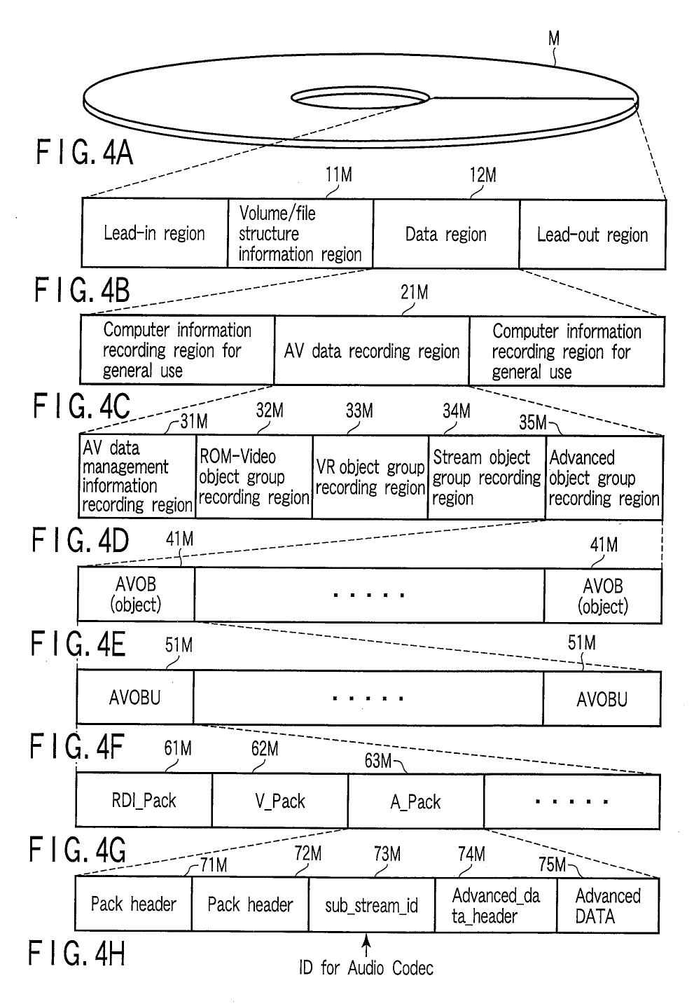

FIGS. 4A to 4H each showing an example of a file system of the expansion DVD format disc described in FIGS. 2 and 3.

As shown in FIGS. 4A to 4H, when the optical disc M reproduced in the optical disc drive unit 3 (see FIG. 1) has the expansion DVD format, in a radial direction of the optical disc M shown in FIG. 4A, as the outline shown in FIG. 4B, at least a volume/file structure information region 11M and a data region 12M are provided between a lead-in region and a lead-out region.

The data region 12M contains at least one AV data recording region 21M, as shown in FIG. 4C.

As shown in FIG. 4D, an AV data management information recording region 31M, a ROM_video object group recording region 32M, a VR object group recording region 33M, a stream object group recording region 34M, and an advanced object group recording region 35M are arranged in the AV data recording region 21M.

As shown in FIG. 4E, an arbitrary number of AVOB (Advanced object) 41M are arranged in the advanced object group recording region 35M. As shown in FIG. 4F, an arbitrary number of AVOBU (Advanced object unit) 51M are provided in each of the AVOB 41M.

As shown in FIG. 4G, each of the AVOBU 51M contains at least RDI_pack (Realtime Data Information pack) 61M, V_pack (Video pack) 62M, and A_pack (Audio pack) 63M.

As shown in FIG. 4H, the A_pack 63M contains a pack header 71M, a packet header 72M, a sub_stream_id 73M, an advanced_data header 74M, and advanced data 75M.

Namely, whether a content service provider as the manufacturer provides sub_audio, or the sub-audio and HBR audio, which is effect_audio, as the advanced content can be easily discriminated by referring to “sub_stream_id” in A_pack in AVOBU (Advanced video object unit) in the advanced object group recording region shown in FIG. 4H.

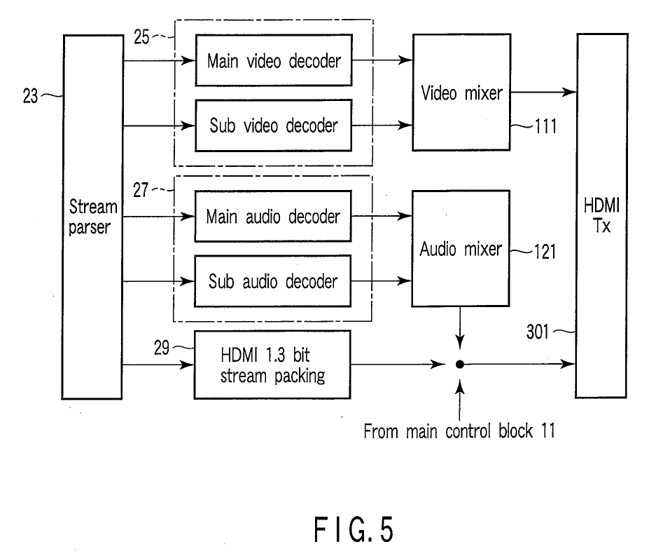

Next, the output signal processing part shown in FIG. 1 will be explained in more detail with reference to FIG. 5.

As described above and shown in FIG. 5, the output signal processing part 101 shown in FIG. 1 has the video system decoder 25, the audio system decoder 27, and the HDMI 1.3 unit 29.

The video system decoder 25 includes a main video decoder 113 and a sub video decoder 115. The output of the video system decoder 25 is mixed by the video mixer 111 to be output to the HDMI input/output part 301.

The audio system decoder 27 includes a main audio decoder 123 and a sub audio decoder 125. The output of the audio system decoder 27 is mixed by the audio mixer 121 to be output to the HDMI input/output part 301.

Meanwhile, the HBR audio signal, which has been separated into the audio signal to be decoded, that is, music or audio, in the stream parser 23, is output as it is from the HDMI input/output part 301 to the TV apparatus A with a built-in speaker, the AV amplifier N connected with a speaker or the like (not shown), or a speaker (not shown) connected to the monitor apparatus B or C (or the speaker may be integrally built in the monitor).

However, since the HBR audio signal contains an audio format with a high sound quality and many channels, such as Dolby Digital Plus, Dolby True HD, and DTS-HD, “sub_audio” and “effect_audio” may not be output simultaneously with the main video (including sub video), depending on the kind of the AV receiver (receiving apparatus) connected through the HDMI input/output part 301 (the HBR audio can be output as a bit stream (bit stream packing) in accordance with the specification of HDMI 1.3 and IEC 6193).

Namely, the HBR audio can provide various audios by decoding the audio stream in the AV receiver (receiving apparatus) side; however, when the AV receiver (receiving apparatus) does not support the HBR audio, needless to say, the sub video is output, but “sub_audio” and “effect_audio” are not reproduced, whereby the user may be confused.

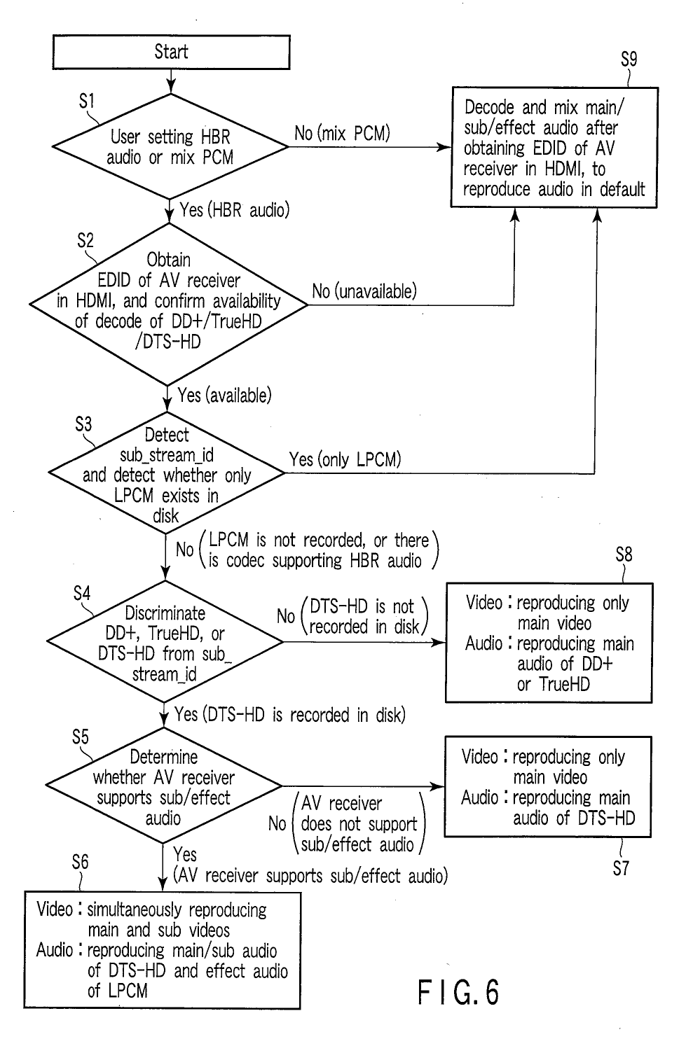

Therefore, only when the HBR audio is selected in accordance with a flow to be described below with reference to FIG. 6, and only when the AV receiver capable of reproducing the HBR audio, which has been determined by a hot plug detection/determination part 201 shown in FIG. 1, is connected (or when the reproduction of the HBR audio has been selected by a user), it is preferable that the HBR audio is output to the HDMI input/output part 301.

Specifically, whether the reproduction of “HBR audio” is selected is determined by the user setting (S1). When the reproduction of “HBR audio” is selected (S1—YES), whether the HBR audio, that is, Dolby Digital Plus (hereinafter referred to as DD+), Dolby True HD (hereinafter referred to as True HD), and DTS-HD can be decoded in the AV receiver (receiving apparatus) is determined on the basis of Extended Display Identification Data (EDID) detected by the hot plug detection/determination part 201 (S2).

In step S2, when it is detected that “HBR audio” can be reproduced in the AV receiver (receiving apparatus), that is, in any of the TV (television) apparatus A, the monitor B, and the AV amplifier N in FIG. 1 (S2—YES), the “sub stream_id” defined in the A_pack in the AVOBU (Advanced video object unit) in the advanced object group recording region (see FIG. 4H) in the content accommodated in the optical disc M is referred. Subsequently, whether the audio signal has only LPCM (Linear PCM) format, that is, whether the HBR audio, which has been formatted by at least one of the format of DD+, True HD, and DTS-HD, is recorded is determined (S3), and then whether audio, which is the HBR audio and formatted by DTS-HD format, is recorded is determined (S4). In steps S3 and S4, when it is detected that audio except LPCM and the audio, which is the HBR audio and formatted by DTS-HD format, are recorded (S3—NO, S4—YES), the reproduction ability of the AV receiver (receiving apparatus) in step S2 is referred (S5). When the AV receiver (receiving apparatus) can reproduce the HBR audio (S5—YES), a video, that is, the main video and the sub video are simultaneously output, while the HBR audio, that is, the main audio and the sub audio of DTS-HD and the effect audio of LPCM are output (S6).

Meanwhile, in step S4, when it is detected that the audio, which is the HBR audio and formatted by DTS-HD format, is recorded (S4—YES), while when the AV receiver (receiving apparatus) does not support the HBR audio (S5—NO), only the main video and the main audio of DTS-HD are output (S7).

In step S4, when it is not detected that the audio, which is the HBR audio and formatted by DTS-HD format, is recorded (S4—NO), only the main video and the main audio of DD+ or True HD are output (S8).

When it is detected that the recorded audio has only LPCM format (S3—YES), when it is detected that the AV receiver (receiving apparatus) supports only mix PCM for the audio reproduction (S2—NO), or when the mix PCM for the audio reproduction is selected by the user in step S1, the main audio and sub audio are decoded by the audio system decoder 27, to be mixed by the audio mixer 121, and thus to be output (S1), in accordance with the reproduction ability of the receiving apparatus (AV receiver) connected based on the EDID, which has been detected by the hot plug detection/determination part 201.

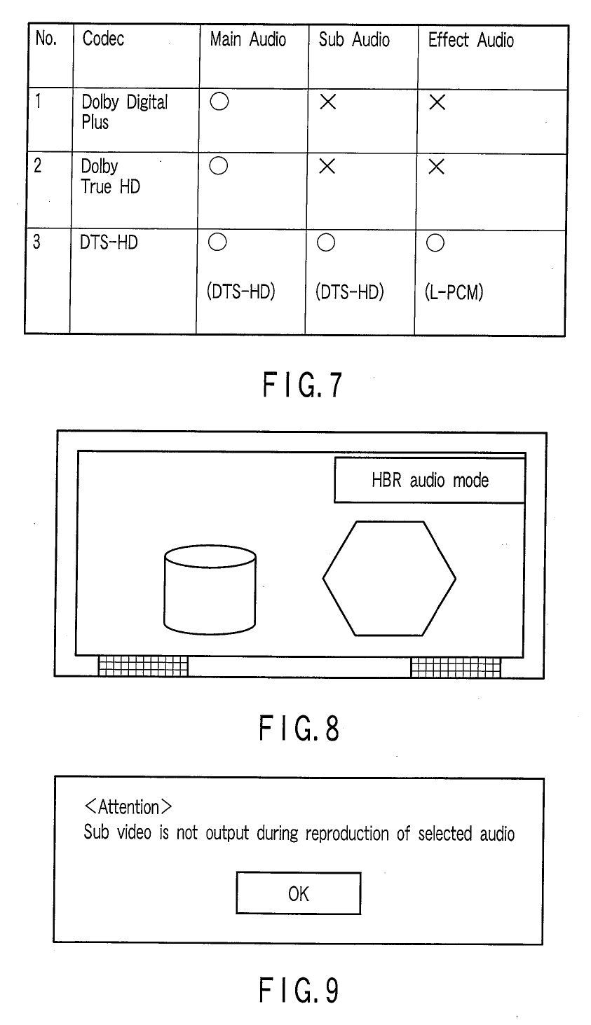

The relation between the HBR audio output and codec, that is, the corresponding format (reproducible audio format) in each AV receiver (receiving apparatus), is shown in FIG. 7.

When the content is actually reproduced, for the purpose of notifying a user that the sub audio, effect audio, and sub video are not reproduced, an OSD 19 displays that the content is being reproduced in “HBR audio mode”, during the reproduction or for a predetermined time after the start of the reproduction, as shown in FIG. 8. When the OSD 19 always displays that the content is being reproduced, the display covers a part of the image, leading to user's irritation. To prevent this problem, for example, when the audio and video are reproduced by the AV amplifier N and the monitor C, the display showing that the HBR audio is being reproduced can be displayed on a front display of the reproducing apparatus (AV amplifier N), or on a display part in a front panel of the player apparatus 1.

When DTS-HD (“HBR audio”) is reproduced, the sub audio and the effect audio are multiplexed with the main audio, and then output from the HDMI input/output part 301 to the corresponding AV receiver (receiving apparatus). Therefore, when the AV receiver which cannot receive the multiplexed HBR audio (cannot decode the sub and effect audios simultaneously) is connected, only the main video and the main audio are output, while the sub video, the sub audio, and the effect audio are not output (are muted), as shown in FIG. 6. In this case, for instance, it is preferable that the alert display is displayed through the OSD 19, as shown in FIG. 9. In addition, also when DD+ (Dolby Digital Plus) and True HD (Dolby True HD) are reproduced, since the sub-audio, the effect-audio, and the sub video cannot be output simultaneously for format reasons, the sub-audio and the effect-audio are muted (not output), without outputting the sub video. Also in this case, the alert display shown in FIG. 9 is displayed by the OSD 19.

The receiving apparatuses (AV receivers), which are an arbitrary number of output apparatuses connected to the player apparatus 1 through the HDMI input/output part 301, that is, the TV apparatus A with a built-in speaker, and the AV amplifier N and the monitor B or C connected to a speaker (not shown), are detected by a hot plug detection part 211 and an EDID decode part 212 in the hot plug detection/determination part 201 shown in FIG. 1, based on the result of the decoding by the EDID decode part 212, that is, the obtained EDID data (extended display identification data). The detection result is transmitted to the main control block 11 by a setting processing part 213. The hot plug detection part 211 detects that an apparatus capable of performing “hot plug detection” has been just connected or has been already connected. The EDID decode part 212 decodes EDID data, which is inherent in each output apparatus and has been obtained from an arbitrary number of apparatuses detected by the hot plug detection part 211. The setting processing part 213 sets a format of audio data, which is to be output to the HDMI input/output part 301, and the resolution of video data. For instance, the TV apparatus A, the monitor B, the monitor C, . . . , and the AV amplifier N are respectively “hot-plug detected” by the detection/determination part 201 (hot plug detection part 211), whereby the EDID of each apparatus is obtained. The detected EDID is decoded by the EDID decode part 212 to be stored in a built-in memory (not shown) or the like of the main control block (CPU) 11 through the setting processing part 213. As the information obtained by decoding, in addition to types of audio format (audio information) capable of being reproduced (audio-outputted) by each sink apparatus or repeater apparatus and the resolution (video information) capable of realizing the display (video-output) in each sink apparatus or repeater apparatus, there are manufacture identification (manufacture ID), product (manufacture) identification (product ID), the serial number, and the like.

As described above, according to one embodiment of the invention, when the HBR audio is reproduced, it is possible to provide a user interface to a user in an easy-to-understand manner in a reproducing mode that cannot simultaneously output the main audio, the sub audio, and the effect audio.

In addition, when the advanced content is reproduced, in the case where an apparatus, which can simultaneously output (reproduce) the sub video, the sub audio, and the effect audio in addition to the main video and the main audio, is connected to the player apparatus, if the user does not designate that the HBR audio is not reproduced, these audio and video data can be output to an apparatus which can reproduce the HBR audio as a bit stream.

Accordingly, the user does not need to set the audio specification (audio format) independently of the video specification to be output, in accordance with the audio reproducing ability of the connected apparatus, whereby the operability is improved, and further the best audio output contained in content is reproduced.

Furthermore, a user can clearly understand whether the audio mode being reproduced is the HBR audio or not.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A video/audio reproducing apparatus comprising:
obtaining means for obtaining a format of audio data and video data, which can be reproduced by first and second audio and video reproducing apparatuses capable of reproducing the audio and video data in an arbitrary format, from the first and second audio and video reproducing apparatuses;
detecting means for receiving bit stream data in the first and second audio and video reproducing apparatuses from among the format of the audio data and video data, which has been obtained by the obtaining means and can be reproduced by the first and second audio and video reproducing apparatuses, and detecting that the reproducing apparatus capable of reproducing the bit stream data is connected; and
output means for directly receiving the bit stream data to output the bit stream data to the reproducing apparatus capable of reproducing the bit stream data, when the detecting means receives the bit stream data and detects that the reproducing apparatus capable of reproducing the bit stream data is connected.

2. The video/audio reproducing apparatus according to claim 1, wherein the bit stream data contains a high bit rate audio signal.

3. The video/audio reproducing apparatus according to claim 1, wherein the output means includes a bidirectional communication interface typified by a High-Definition Multimedia Interface (HDMI).

4. A video/audio reproducing apparatus comprising:
content detection means for detecting that advanced content with an extended DVD format is contained in a recording medium to be reproduced;
obtaining means for obtaining a format of audio data and video data, which can be reproduced in first and second audio and video reproducing apparatuses capable of reproducing the audio and video data in an arbitrary format, from the first and second audio and video reproducing apparatuses;
detecting means for detecting connection of a reproducing apparatus capable of reproducing bit stream data in the first and second audio and video reproducing apparatuses from among the format of the audio data and video data, which has been obtained by the obtaining means and can be reproduced by the first and second audio and video reproducing apparatuses; and
output means for directly outputting the bit stream data to the reproducing apparatus capable of reproducing the bit stream data, when the detecting means detects that the reproducing apparatus capable of reproducing the bit stream data is connected, and when the content detection means detects that the bit stream data is contained in the recording medium.

5. The video/audio reproducing apparatus according to claim 4, wherein the output means is capable of selectively outputting the audio data and the video data having a format different from that of the bit stream data.

6. The video/audio reproducing apparatus according to claim 4, wherein the output means prevents the output of the bit stream data and the corresponding video data when the detecting means detects that the reproducing apparatus capable of reproducing the bit stream data is not connected.

7. The video/audio reproducing apparatus according to claim 4, further comprising:
display means for notifying that the output means outputs the bit stream data to the reproducing apparatus capable of reproducing the bit stream data.

8. A method for outputting a signal in a video/audio reproducing apparatus, comprising:
detecting that specified content is contained in a recording medium to be reproduced;
obtaining an audio format and a video format which can be reproduced by a first audio and video reproducing apparatus capable of reproducing audio data and video data in an arbitrary format;
obtaining an audio format and a video format which can be reproduced by a second audio and video reproducing apparatus capable of reproducing audio data and video data in an arbitrary format;
detecting that a reproducing apparatus capable of reproducing bit stream data in the first and second audio and video reproducing apparatuses is connected; and
directly outputting the bit stream data to the detected reproducing apparatus capable of reproducing the bit stream data.
